(19) United States
(12) Patent Application Publication
(10) Pub. No.: US 2007/0118583 A1
(43) Pub. Date: May 24, 2007

(54) Complex coefficient transversal filter and radio communication system employing the same

(75) Inventor: Hiroyuki Nagasaka, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 11/603,047

(22) Filed: Nov. 22, 2006

(30) Foreign Application Priority Data
Nov. 22, 2005 (JP) 2005-337593
Oct. 13, 2006 (KR) 10-2006-0100010

(51) Int. Cl. G06F 17/10

(52) U.S. Cl. 708/319

(57) ABSTRACT

A radio communication system, method, and apparatus using a complex coefficient transversal filter which removes an image are provided. Accordingly, it is possible to improve an image suppression ratio over a wide band by applying the complex coefficient transversal filter which removes an image by using a phase delay of real and imaginary signals to a multi-band, wide-band portable radio communication system. In addition, it is possible to reduce a circuit's size and power consumption.

### CROSS-REFERENCE TO RELATED PATENT APPLICATION

This application claims priority from Japanese Patent Application No. 2005-337593, filed on Nov. 22, 2005, in the Japanese Intellectual Property Office, and Korea Patent Application No. 10-2006-0100010, filed on Oct. 13, 2006, in the Korea Intellectual Property Office, the disclosures of which are incorporated herein in their entirety by reference.

### BACKGROUND OF THE INVENTION

1. Field of the Invention

Systems, methods and apparatuses consistent with the present invention relate to radio communication using a complex coefficient transversal filter which removes an image, and more particularly, to a radio communication system, using a complex coefficient transversal filter which removes an image by using phase delay of real and imaginary signals.

2. Description of the Related Art

Radio communication systems can use a heterodyne method, a low intermediate frequency (low-IF) method, or a direct-conversion method to receive and transmit radio frequency (RF) signals.

A heterodyne receiver converts a received RF signal to an IF signal and then to a baseband signal. In the heterodyne receiver, an image is removed by using two filters: a bandpass filter (BPF) which has a high selectivity to an RF band and another BPF which has a high rejection to an IF band. In recent communication systems, since the frequency band of signals is narrow, it is easy to remove the image. However, in a radio communication system of mobile radio apparatuses which are widely used, multiple wide bands are required. Such a radio communication system may remove the image using a poly-phase filter, which is a complex coefficient filter constructed of resistors and condensers. In order to implement the high rejection and wide band characteristics which are requirements of the radio communication system, multiple filter stages may be provided. However, in this case, insertion loss increases, and it is difficult to remove the image enough to satisfy the requirements of the radio communication system.

The direct-conversion method is one type of simple radio communication system capable of implementing multi-band, wide band communication. In the direct conversion receiver, the received RF signal is directly converted to a baseband signal. On the other hand, in the low-IF receiver, the received RF signal is converted to an IF signal which is slightly shifted from the baseband signal. In these cases, since the IF is low, it is difficult to remove the image.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a radio communication system and method using a complex coefficient transversal filter which removes an image by using phase delay of real and imaginary signals so as to improve an image suppression ratio and reduce a circuit's size and power consumption.

According to an aspect of the present invention, there is provided a complex coefficient transversal filter comprising: a real signal generator which generates two or more real delay signals by delaying an input signal by an integer multiple of one period, generates two or more real multiplied signals by multiplying the input signal and at least one of the real delay signals by the absolute value of a real variable tap coefficient, and generates a real signal by sequentially adding two or more real multiplied signals; and an imaginary signal generator which generates a phase delay signal by delaying the input signal by half a period, generates two or more imaginary delay signals by delaying the phase delay signal by an integer multiple of one period, generates two or more imaginary multiplied signals by multiplying the phase delay signal and at least one of the imaginary delay signals by the absolute value of an imaginary variable tap coefficient, and generates an imaginary signal by sequentially adding two or more imaginary multiplied signals.

The real signal generator may comprise M real signal coefficient multipliers, each of which generates the real multiplied signal by multiplying the phase delay signal and at least one of the real delay signals by the absolute value of the real variable tap coefficient, and M is an integer of 5 or more.

The imaginary signal generator may comprise (M−1) imaginary signal coefficient multipliers, each of which generates the imaginary multiplied signal by multiplying the phase delay signal and at least one of the imaginary delay signals by the absolute value of the imaginary variable tap coefficient.

The real signal generator may comprise (M−1) adders, each of which receives at least two of the real multiplied signals through a polarity allocating terminal and adds the real multiplied signals input through the polarity allocating terminal to generate the real signal, and M is an integer of 5 or more, and wherein the polarity allocating terminal alternately allocates positive and negative polarities to the input signal.

The imaginary signal generator may comprise (M−2) adders, each of which receives at least two of the imaginary multiplied signals through a polarity allocating terminal and adds the imaginary multiplied signals input through the polarity allocating terminal to generate the imaginary signal, and wherein the polarity allocating terminal alternately allocates positive and negative polarities to the input signal.

The M real signal coefficient multipliers may include: first, second, and M-th real signal coefficient multipliers having an absolute value of the real variable tap coefficient is less than 1; and third to (M−2)-th real signal coefficient multipliers having an absolute value of the real variable tap coefficient is equal to 1.

The (M−1) imaginary signal coefficient multipliers includes: first and (M−1)-th imaginary signal coefficient multipliers having an absolute value of the imaginary variable tap coefficient is in the range of the sum of the absolute values of the real variable tap coefficients of the first and second real signal coefficient multipliers multiplied by 0.4 to 0.6; and second to (M−2)-th imaginary signal coefficient multipliers having an absolute value of the imaginary variable tap coefficient equal to 1.

The real signal generator may include (M−1) real signal delayers, each of which delays a received signal by one period to output the real delay signal, and wherein the (M−1) real signal delayers are arrayed in series.

The imaginary signal generator may include: a phase delayer which delays the input signal by half a period to generate the phase delay signal; and (M−2) imaginary signal delayers, each of which delays a received signal by one period to output the imaginary delay signal, and wherein the first imaginary signal delayer of the (M−2) imaginary signal delayer is connected in series with the phase delayer, and the (M−2) imaginary signal delayers are connected in series with each other.

The complex coefficient transversal may further comprise a transmission electrode unit which transforms the input signal into a surface acoustic wave (SAW) signal and outputs the SAW signal to the real and imaginary signal generators.

The transmission electrode unit may comprise positive and negative transmission electrodes including comb-like fingers facing each other on a substrate made of a piezoelectric material, and the transmission electrode unit may receive an electrical signal through an input terminal of the transmission electrode unit which is connected to the positive and negative transmission electrodes and transmit the SAW signal through output terminals of the transmission electrode unit which are respectively connected to the positive and negative transmission electrodes.

The real signal generator may comprise positive and negative real electrodes including comb-like fingers facing each other on a substrate made of a piezoelectric material, and the real signal generator may receive the SAW signal through a real input terminal which is connected to the positive and negative real electrodes and apply an electrical signal through a real output terminal.

The imaginary signal generator may comprise positive and negative imaginary electrodes including comb-like fingers facing each other on a substrate made of a piezoelectric material, and the imaginary signal generator may receive the SAW signal through an imaginary input terminal which is connected to the positive and negative imaginary electrodes and apply an electrical signal through an imaginary output terminal.

The real electrode unit may adjust the absolute value of the real variable tap coefficient according to the degree of overlap of the fingers of the positive and negative real electrodes.

The imaginary electrode unit may adjust the absolute value of the imaginary variable tap coefficient according to the degree of overlap of the fingers of the positive and negative imaginary electrodes.

The real electrode unit may be constructed by alternating the fingers of the positive and negative real electrodes.

The imaginary electrode unit may be constructed by alternating the fingers of the positive and negative imaginary electrodes.

The real electrode unit may adjust a delay time according to the pitch of the real fingers.

The imaginary electrode unit may adjust a delay time according to the pitch of the imaginary fingers.

According to another aspect of the present invention, there is provided a filtering method, comprising: generating a real signal by delaying an input signal by a first value, multiplying the resulting signal by a second value, and sequentially adding multiplied values; and generating an imaginary signal by delaying the input signal by a third value, multiplying the resulting signal by a fourth value, and sequentially adding multiplied values.

The generating the real signal may comprise: delaying the input signal by an integer multiple of one period to generate two or more real delay signals; multiplying the input signal and at least one of the real relay signals by the absolute value of a real variable tap coefficient to generate two or more real multiplied signals; and sequentially adding two or more real multiplied signals to generate the real signal.

The generating the imaginary signal may comprise: delaying the input signal by half a period to generate a phase delay signal; delaying the phase delay signal by an integer multiple of one period to generate two or more imaginary delay signals; multiplying the phase delay signal and at least one of the imaginary delay signals by the absolute value of an imaginary variable tap coefficient to generate two or more imaginary multiplied signals; and sequentially adding two or more imaginary multiplied signals to generate the imaginary signal.

According to another aspect of the present invention, there is provided a receiver comprising: a complex coefficient transversal filter which generates a real signal by delaying an input signal by a first value, multiplying the result by a second value, and sequentially adding multiplied values, and generates an imaginary signal by delaying the input signal by a third value, multiplying the result by a fourth value, and sequentially adding multiplied values; a frequency converter which converts the frequency of a signal generated by a complex coefficient transversal filter; and a demodulator which demodulates a signal converted by the frequency converter.

According to another aspect of the present invention, there is provided a transmitter comprising: a modulator which modulates a baseband signal; a frequency converter which converts the frequency of a signal modulated by the modulator; and a complex coefficient transversal filter which generates a real signal by delaying the signal converted by the frequency converter by a first value, multiplying the result by a second value, and sequentially adding multiplied values, and generates an imaginary signal by delaying the signal converted by the frequency converter by a third value, multiplying the result by a fourth value, and sequentially adding multiplied values.

### BRIEF DESCRIPTION OF THE DRAWINGS

The above and aspects of the present invention will become more apparent by describing in detail exemplary embodiments thereof with reference to the attached drawings in which:

FIG. 1 is a block diagram of a complex coefficient transversal filter which removes an image according to an exemplary embodiment of the present invention;

FIG. 2A is a graph showing an arrangement of variable tap coefficients according to an exemplary embodiment of the present invention;

FIG. 2B is a graph of frequency characteristics according to the exemplary embodiment of the present invention;

FIG. 3A is a graph showing an arrangement of variable tap coefficients according to another exemplary embodiment of the present invention;

FIG. 3B is a graph of frequency characteristics according to the exemplary embodiment of the present invention;

FIG. 4A is a graph showing an arrangement of variable tap coefficients according to another exemplary embodiment of the present invention;

FIG. 4B is a graph of frequency characteristics according to the exemplary embodiment of the present invention;

FIG. 5 is a graph showing the relationship between imaginary variable tap coefficients and frequency characteristics according to the present invention;

FIG. 6 is a graph showing an arrangement of variable tap coefficients according to another exemplary embodiment of the present invention;

FIG. 7 is a graph of frequency characteristics according to the exemplary embodiment of the present invention;

FIG. 8 shows a complex coefficient transversal SAW filter according to another exemplary embodiment of the present invention;

FIG. 9 shows a real electrode portion according to the exemplary embodiment of the present invention;

FIG. 10 is a graph showing frequency conversion in a low-IF receiver;

FIG. 11 is a block diagram of a receiver using a complex coefficient transversal filter which removes an image according to the present invention;

FIG. 12 is a graph showing frequency conversion in the receiver using the complex coefficient transversal filter which removes an image according to one of the exemplary embodiments of the present invention;

FIG. 13 is a block diagram of a related art super-heterodyne receiver;

FIG. 14 is a graph showing frequency conversion in the related art super-heterodyne receiver;

FIG. 15 is a block diagram of a low-IF receiver using the complex coefficient transversal filter which removes an image according to the present invention;

FIG. 16 is a block diagram of a transmitter using the complex coefficient transversal filter which removes an image according to the present invention;

FIG. 17 is a graph showing frequency conversion in a direct-conversion transmitter; and

FIG. 18 is a graph showing frequency conversion in a direct-conversion transmitter using the complex coefficient transversal filter which removes an image according to the present invention.

### DETAILED DESCRIPTION OF THE EXEMPLARY EMBODIMENTS OF THE INVENTION

The present invention will now be described in detail by explaining exemplary embodiments of the invention with reference to the attached drawings. For simplicity, well-known functions or elements may not be described in detail. Terms in the specification are defined taking into consideration the functions and operation of the exemplary embodiments of the present invention. Therefore, definitions of terms used herein should be determined on the basis of the whole specification.

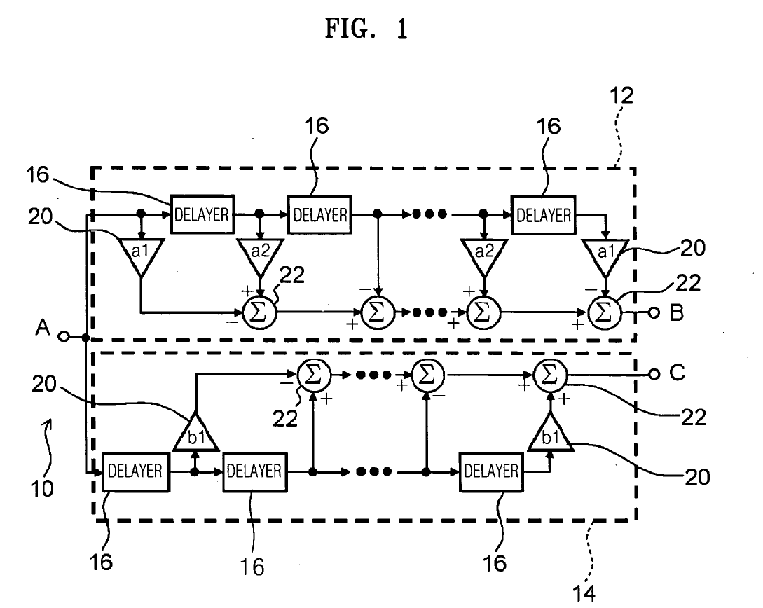

FIG. 1 is a block diagram of complex coefficient transversal filter 10 which removes an image according to an exemplary embodiment of the present invention.

The complex coefficient transversal filter 10 includes real and imaginary signal generators 12 and 14. An input signal input from a common input terminal A is branched into the real and imaginary signal generators 12 and 14. The real signal of the real signal generator 12 is obtained from an output terminal B, and the imaginary signal of the imaginary signal generator 14 is obtained from an output terminal C. Each complex coefficient transversal filter 10 includes delayers 16, adders 22, and coefficient multipliers 20.

The delayer 16 has a function of delaying a signal by one clock cycle, that is, one period T. The delayer 16 may be constructed of D-flip-flops or the like. The adder 22 and the coefficient multiplier 20 may be constructed of logic circuits. The coefficient multipliers 20 between the input terminal A of the complex coefficient transversal filter 10 and the adder 22 and the coefficient multiplier 20 connecting the output of the delayer 16 and the adder 22 are sometimes referred to as taps. A coefficient multiplier with an absolute coefficient value of 1 is equivalent to a connection line which connects the output terminal of the delayer 16 and the input terminal of the adder to a negative or positive. The coefficient multiplier with an absolute coefficient value of 1 is also treated as a tap.

For example, in the real signal generator 12 shown in FIG. 1, a first tap is a coefficient multiplier 20 with a coefficient a1, and a second tap is a coefficient multiplier 20 with a coefficient a2. A first delayer 16 with a delay time T is inserted between the input terminals of the coefficient multipliers 20 with the coefficients a1 and a2. The outputs of the coefficient multipliers 20 are added to the first adder 22. In the exemplary embodiment of the present invention, the third coefficient multiplier 20 and the next coefficient multipliers 20 are assumed to have coefficient of 1. In addition, a coefficient multiplier 20 connected to the output terminal B has a coefficient a1, and a coefficient multiplier 20 connected to the coefficient multiplier with the coefficient a1 has a coefficient a2.

In the imaginary signal generator 14 shown in FIG. 1, the output of a first delayer 16 with a delay time of T/2 connected to the output terminal A is connected to a first coefficient multiplier 20 with a coefficient b1 and a second delayer 16. In this case, the first coefficient multiplier 20 is a first tap. In addition, a second tap is directly connected to a delayer 16 with an output delay time T and an adder 22. After the second tap, the coefficient multipliers 20 have a coefficient of 1, and the output of the last delayer 16 is connected through a coefficient multiplier 20 with a coefficient b1 to the output terminal C, similarly to the first tap.

In the real signal generator 12, the number of real signal coefficient multipliers 20, that is, the number of taps, is M, where M is an integer of 5 or more. The number of real signal delayers 16 is (M−1), and the number of real signal adders 22 is (M−1). In the imaginary signal generator 14, the number of imaginary signal coefficient multipliers 20, that is, the number of taps, is M, the number of imaginary signal delayers 16 is (M−1), and the number of imaginary signal adders 22 is (M−2). In the exemplary embodiment of the present invention, the first two real signal coefficient multipliers 20 near the input terminal A of the real signal generator 12 and the last two real signal coefficient multipliers 20 near the output terminal B of the real signal generator 12 have an absolute coefficient value smaller than 1. Other real signal coefficient multipliers may have an absolute coefficient value of 1.

In the imaginary signal generator 14, the first and last imaginary signal coefficient multipliers 20 have a coefficient b1. Other imaginary signal coefficient multipliers 20 may be taps having an absolute coefficient value of 1.

A transversal complex coefficient filter 10 constructed of a digital circuit having |a1|=0.5, |a2|=0.5, and |b1|=0.48 will now be described with reference to simulation results.

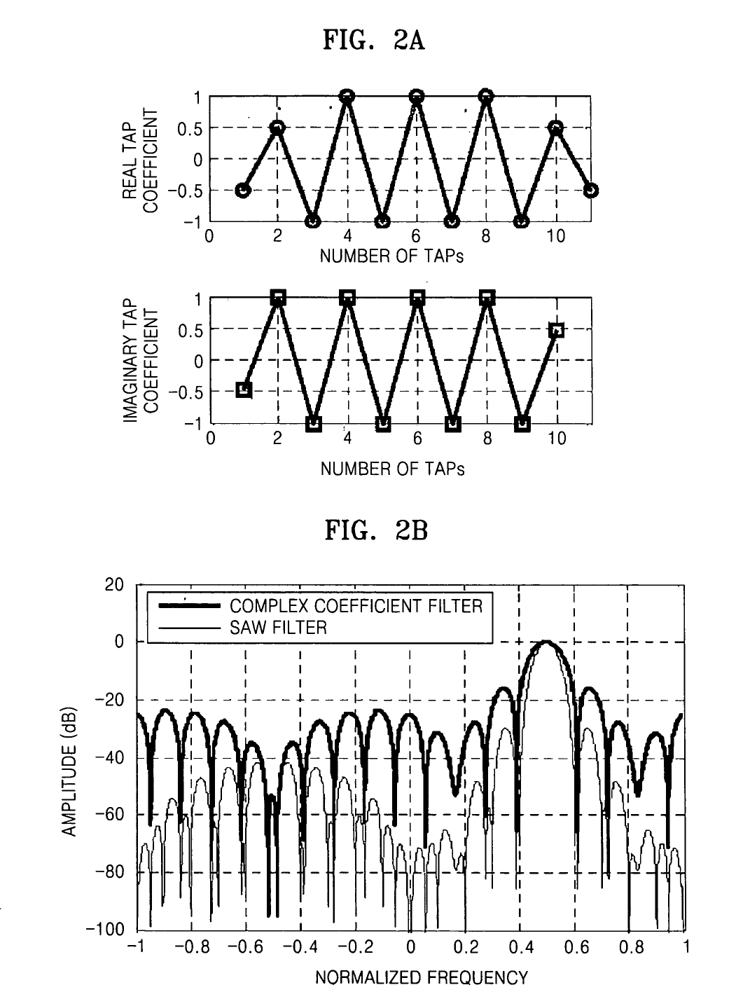

FIG. 2A is a graph showing an arrangement of variable tap coefficients according to an exemplary embodiment of the present invention.

FIG. 2B is a graph of frequency characteristics according to the exemplary embodiment of the present invention.

The simulation was carried out using MATLAB®. The characteristics of the complex coefficient filter 10 according to the exemplary embodiment of the present invention are denoted by a bold solid line. A thin solid line denotes the characteristics of a complex coefficient transversal SAW filter, which is described later in detail.

In the real signal generator, the first tap has a coefficient a1=−0.5, and the second tap has a coefficient a2=0.5. The third to ninth taps have coefficients having an absolute value of 1 and alternating positive and negative signs. The tenth tap has a coefficient a2=0.5, and the eleventh tap has a coefficient a1=−0.5. In the imaginary signal generator, the first tap has a coefficient b1=−0.48, and the second to ninth taps have coefficients having an absolute value of 1 and alternating positive and negative signs. The last tap has a coefficient b1=0.48. In this case, a relationship of |b1|=(|a1|+|a2|)×(a value of 0.4˜0.6) may be selected. The sign denotes the polarity of a signal input to the adder, and plus and minus respectively denote addition and subtraction. As shown in FIGS. 1 and 2A, the signs of the signals added from the taps are alternately positive and negative.

In FIG. 2B, the horizontal axis denotes normalized frequency, and the vertical axis denotes the amplitude (in dB) of a signal passing through a filter. A central frequency of a pass band corresponds to a normalized frequency of 0.5. At the central frequency, attenuation of the amplitude is almost zero. At a normalized frequency of −0.5, that is, an image frequency, the amplitude is about −53 dB, so that more than sufficient attenuation can be obtained in comparison with a desired frequency. Thus, image suppression can be implemented by using the simple construction of filters shown in FIG. 2A.

Amplitude-frequency characteristics according to changes in variable tap coefficients a1, a2, and b1 will now be described.

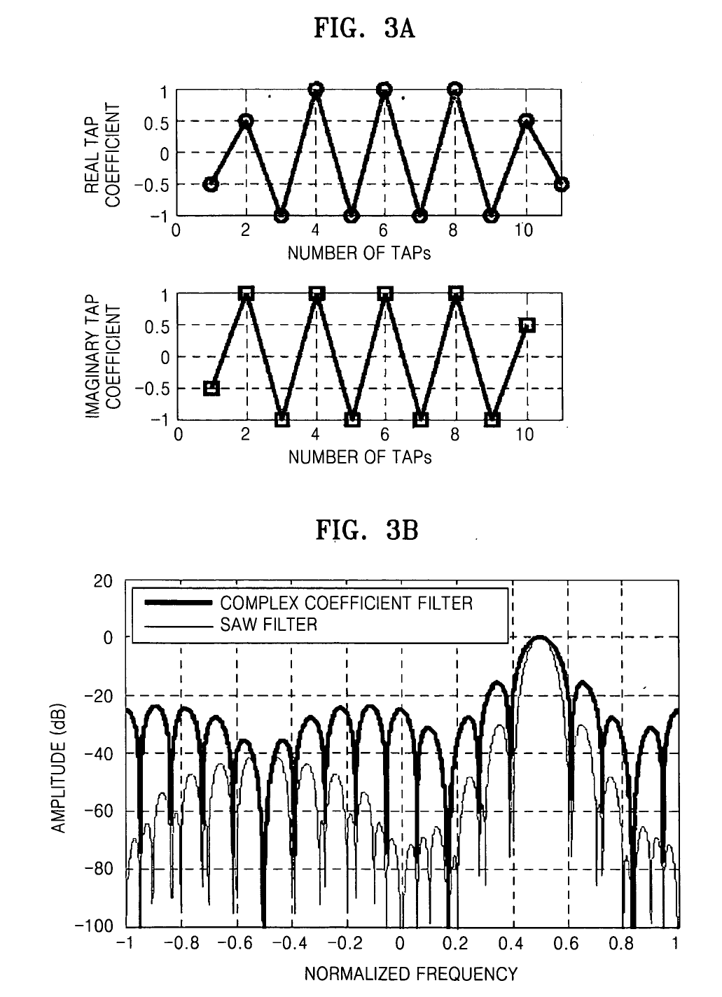

FIG. 3A is a graph showing an arrangement of variable tap coefficients according to another exemplary embodiment of the present invention.

As shown in FIG. 3A, the real variable tap coefficients a1 and a2 are designed to be 0.5, similarly to the above exemplary embodiment. The imaginary variable tap coefficient b1 is designed to be 0.5.

FIG. 3B is a graph of frequency characteristics according to the exemplary embodiment of the present invention.

As shown in the figures, a pass band near the desired normalized frequency of 0.5 corresponds to low insertion loss, similarly to the above exemplary embodiment. At the image frequency of −0.5, the amplitude is −100 dB or less, so that large attenuation of the image signal can be obtained. However, the length of the band having the large attenuation is narrow in comparison with the above exemplary embodiment.

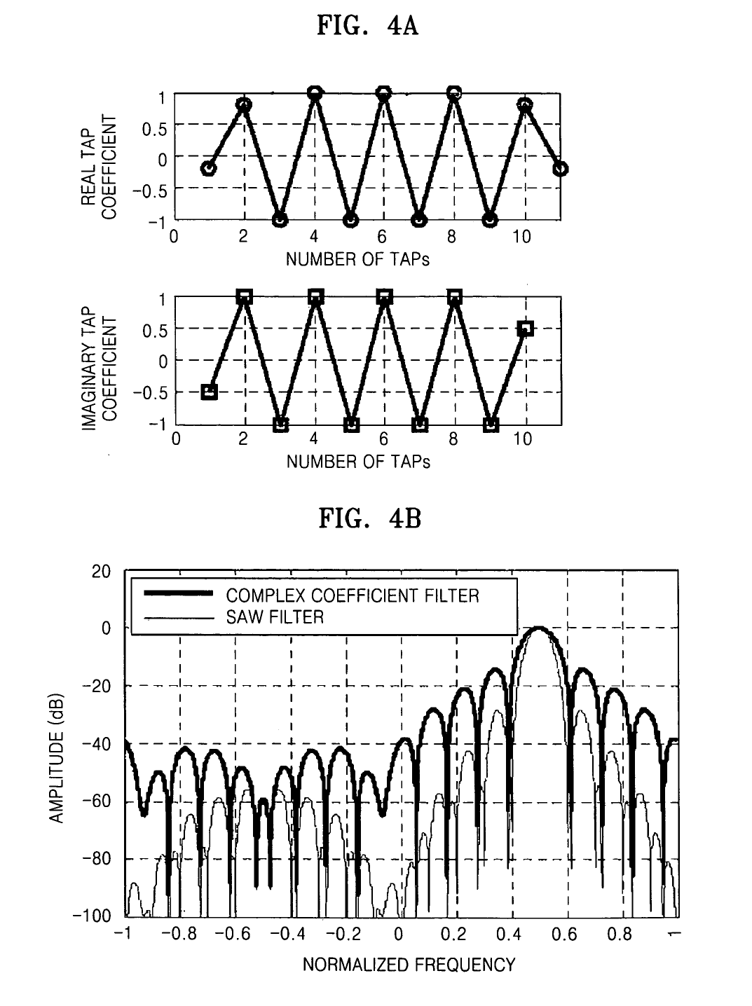

FIG. 4A is a graph showing an arrangement of variable tap coefficients according to another exemplary embodiment of the present invention. In the exemplary embodiment, as shown in FIG. 4A, a1=−0.2, a2=0.8, and |b1|=0.49.

FIG. 4B is a graph of frequency characteristics according to another exemplary embodiment of the present invention.

Similarly to the exemplary embodiment, a pass band near the desired frequency has low insertion loss. At the image frequency, the amplitude is about −58 dB, which is slightly larger than in the exemplary embodiment. In addition, the frequency band having large attenuation is wider than that of the exemplary embodiment.

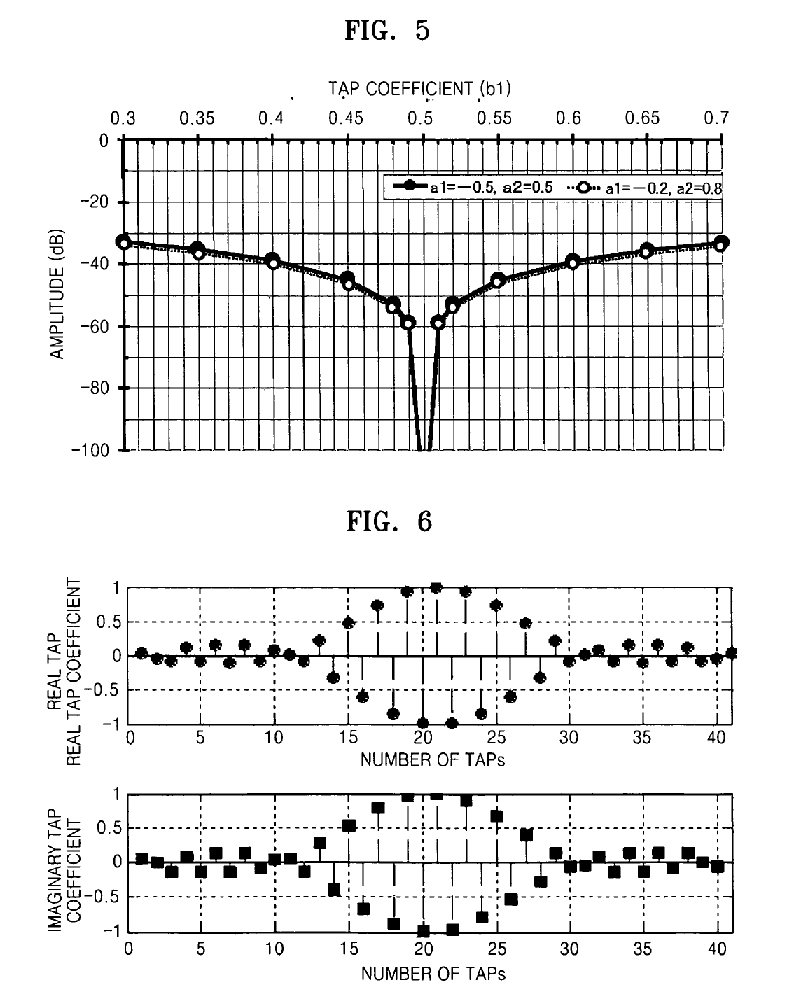

FIG. 5 is a graph showing the relationship between an imaginary variable tap coefficient and frequency characteristics. The graph shows that attenuation is dependent on b1 near the image frequency.

In the graph, the solid line denotes attenuation according to b1 when a1=−0.5 and a2=0.5. The dotted line denotes attenuation according to b1 when a1=−0.2 and a2=0.8. At |b1|=0.5, the attenuation goes to infinity. When |b1| is larger or smaller than 0.5, the attenuation is less.

As described in the three aforementioned exemplary embodiments, a rapid change in the amplitude and the frequency characteristics near the image frequency can be controlled by adjusting three variables a1, a2, and b1. As a result, a filter suitable for a communication system can be implemented by adjusting the three variables.

Next, a complex coefficient transversal filter according to another exemplary embodiment of the present invention will be described. Generally, in the case of a high frequency and multiple modulation, in order to remove an image more effectively, a complex coefficient transversal filter is used. In designing a complex coefficient transversal filter, the number of taps are increased so as to change the coefficient by a small increment with each tap.

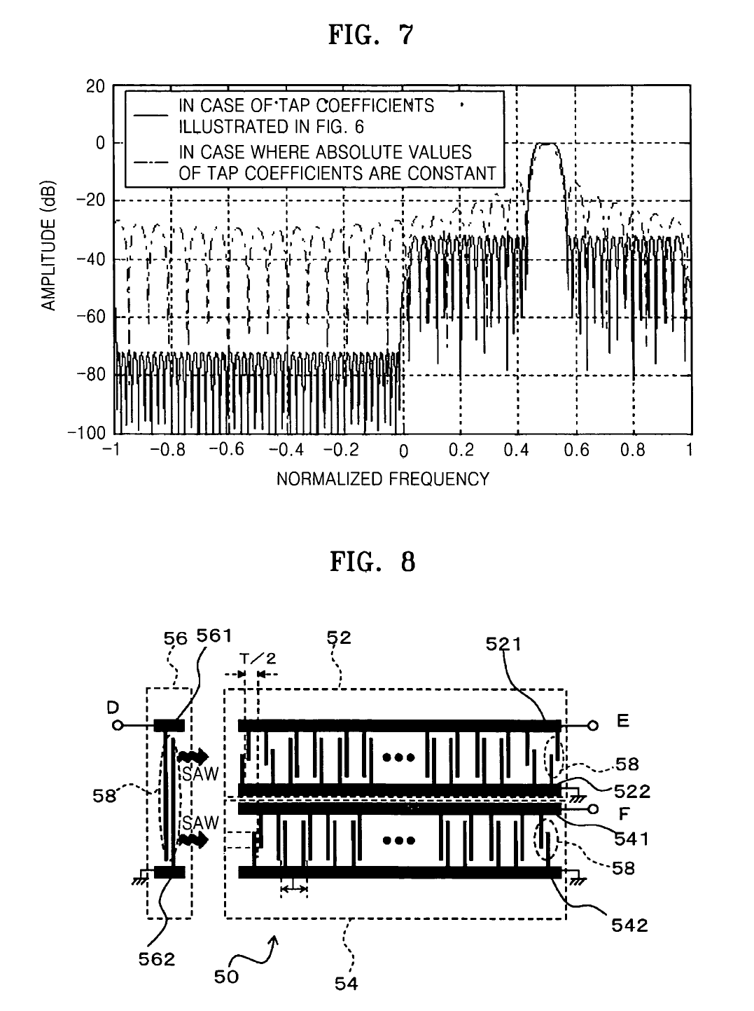

FIG. 6 shows graphs of arrangements of variable tap coefficients according to the exemplary embodiment of the present invention. The number of variable taps is 41, and the variable tap coefficient changes gradually. The upper graph shows an arrangement of real tap coefficients, and the lower graph shows an arrangement of imaginary tap coefficients.

FIG. 7 is a graph of frequency characteristics according to the exemplary embodiment.

At the image frequency of −0.5, the amplitude is −70 dB or less, which is enough to remove the image. Although the number of variable taps (41) is large, a central tap has an absolute coefficient value of 1, which reduces the circuit size and power consumption. In FIG. 6, the dotted line denotes the amplitude characteristics of 11 taps having predetermined coefficients. The real tap coefficients are −1, 1, −1, 1, −1, 1, −1, 1, −1, 1, and −1, and the imaginary tap coefficients are −1, 1, −1, 1, −1, 1, −1, 1, −1, and 1. At the image frequency, the amplitude is about −30 dB.

FIG. 8 shows a complex coefficient transversal SAW filter 50 according to another exemplary embodiment of the present invention.

Piezoelectric materials such as lithium tantarate LiTaO₃, lithium nitride LiNbO₃, and quartz may be used as a medium for transmitting the SAW. Advances in micro machining technology have allowed the manufacture of a SAW filter having good performance at frequencies over 3 GHz.

An input terminal D corresponding to the input terminal A of the first exemplary embodiment is connected to a positive electrode 561 of a transmission electrode unit 56. A negative electrode 562 is connected to ground. Comb-like fingers 58 are arranged to face each other on a substrate made of a piezoelectric material. The fingers of the positive electrode 561 alternate with the fingers of the negative electrode 562. When an input signal is received, the fingers excite the SAW due to the piezoelectric effect. A large number of the fingers 58 may be used.

The transmitted SAW is converted into an electric signal in a positive real electrode 521 of a real signal generator 52, and the electric signal is output through an output terminal E corresponding to the output terminal B of the first exemplary embodiment. A negative electrode 522 of the real signal generator 52 is connected to ground. The real signal generator 52 is constructed of the positive and negative electrodes 521 and 533 having the comb-like fingers 58 facing each other.

The fingers 58 shown in FIG. 8 have similar tap coefficients to those shown in FIG. 1. If the fingers completely overlap with each other, the tap coefficient is 1. If the fingers do not completely overlap with each other, the tap coefficient is 0. The real signal generator 52 has a large number of the fingers 58 having a delay time of T (one period) arranged in the SAW transmission direction.

In a finger unit of a tap of the reception electrode, the finger connected to the positive electrode is close to the transmission electrode 56. In the next finger unit 58, the finger connected to the negative electrode is close to the transmission electrode 56. This alternating arrangement of fingers corresponds to the alternating signs of a1 and a2.

Similarly, the SAW is transmitted through a positive imaginary electrode 541 of an imaginary signal generator 54 to an output terminal F corresponding to the output terminal C of the exemplary embodiment. A negative imaginary electrode 542 of the imaginary signal generator 54 is connected to ground. In this case, the fingers 58 are arranged at a predetermined pitch so that the delay time is one period T. The number of pairs of imaginary positive and negative electrode fingers is one less than the number of pairs of real positive and negative electrode fingers, so that the delay time deceases by half period T/2. Therefore, the construction is equivalent to that of a digital circuit shown in FIG. 1.

A frequency characteristic of the amplitude of a complex coefficient SAW filter having tap coefficients of |a1|=|a2|=0.5 and |b1|=0.48 shown in FIG. 2A according to the exemplary embodiment is represented with a thin solid line in FIG. 2B. In this exemplary embodiment, similar to the exemplary embodiment, insertion loss at a desired frequency can be zero, and the amplitude in the vicinity of the image frequency can be −55 dB. In the other frequency bands, other noise as well as the image can be removed. Similarly, as shown in FIGS. 4 and 5, the complex coefficient transversal SAW filter can have similar characteristics to the complex coefficient transversal filter constructed of a digital circuit.

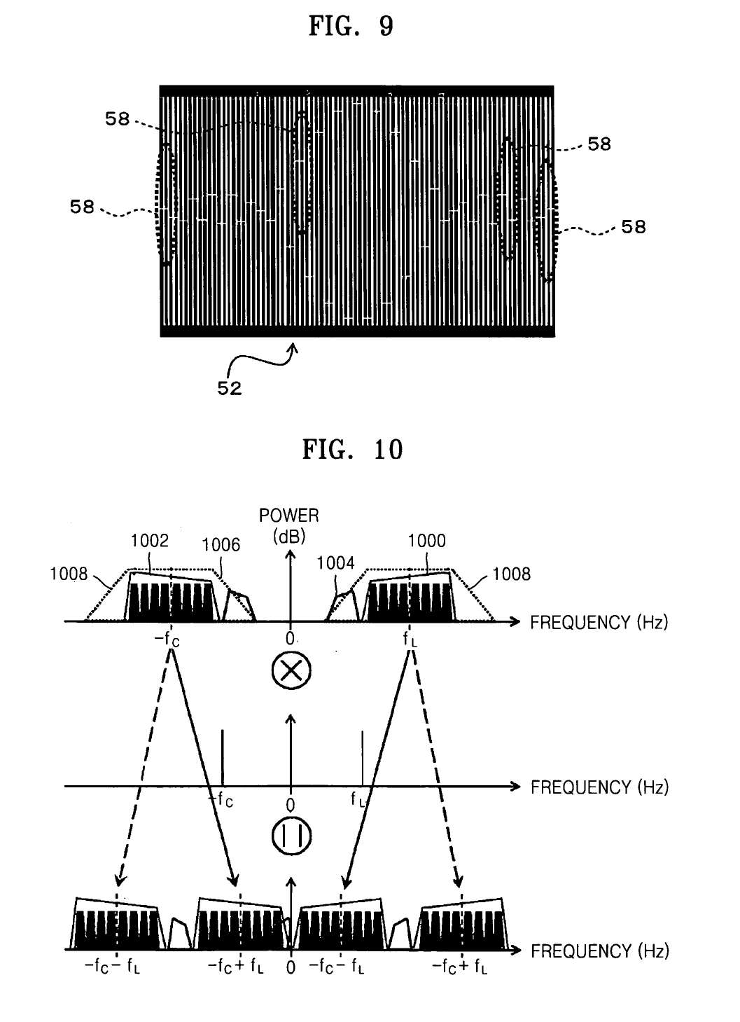

FIG. 9 shows the real electrode unit according to the exemplary embodiment of the present invention.

More specifically, FIG. 9 is a schematic plan view showing a real reception electrode inside the real electrode unit. As the frequency increases, the width of each finger and the pitch of the fingers corresponding to the delay time decrease. In the exemplary embodiment, in order to prevent unnecessary performance loss caused by unnecessary reflection of the SAW between the fingers, two fingers constitute a pair.

In the exemplary embodiment, the frequency characteristic of amplitude suitable to effectively suppress the image can be obtained by adjusting three coefficients a1, a2, and b1 as shown in FIG. 2B. In addition, since |b1 b1|=(|a1|+|a2|)×(0.4 about 0.6), the coefficient b1 can be selected as a suitable value. In addition, regions which do not have the coefficient of 1 are limited to both ends of the filter. Therefore, regions of electrodes having a small acoustic excitation effect can be minimized, the insertion loss of the filter can be lowered, and the size of the filter can be reduced.

In the exemplary embodiments, the filters can use a simpler circuit construction than various related art filters. In addition, such a transversal filter can be constructed of a digital or analog circuit, and can have various applications and controllable attenuation characteristics. For example, by designing only the absolute values of at least three tap coefficients, the image suppression ratio can be improved, and the image signals at two frequencies can be removed.

Next, operations of suppressing the image by using a simply-constructed complex coefficient filter will be described in detail.

FIG. 10 is a graph showing frequency conversion in a low-IF receiver.

A desired signal having a central frequency of fc is denoted by a system signal 1000 of a multi-band or wide-band system. An image signal 1002 associated with the system signal 1000 has a central frequency of −fc. In addition, in the vicinity of the system signal, there are other system signals or noise 1004. For example, in the upper graph of FIG. 10, other system signals or noise 1004 exist in a slightly lower frequency band than the frequency of the system signal. These signals overlap, and an image signal 1006 of the other system signals or noise exists in the vicinity of the image signal (the left side of the image signal in FIG. 10). In a radio frequency bandpass filter (RF BPF) 1008 having bandpass characteristics denoted by the dotted line in the upper graph of FIG. 10, it is difficult to remove other system signals or noise 1004.

An intermediate frequency (IF) (=fc−fL) of the low-IF filter is designed to be lower than that of a super-heterodyne filter. For example, the IF is selected from a range below a few MHz. In the lower graph of FIG. 10, since there is a large difference in frequency between signals having central frequencies of fc−fL and fc+fL, it is easy to extract only the signal having the central frequency of fc−fL. In addition, the desired frequency fc−fL transformed from the system signal overlaps the frequency −fc+fL of the image signal of other system signals or noise 1004 and the frequency of the image signal of the system signal. Communication quality may be greatly reduced by the interference of the image.

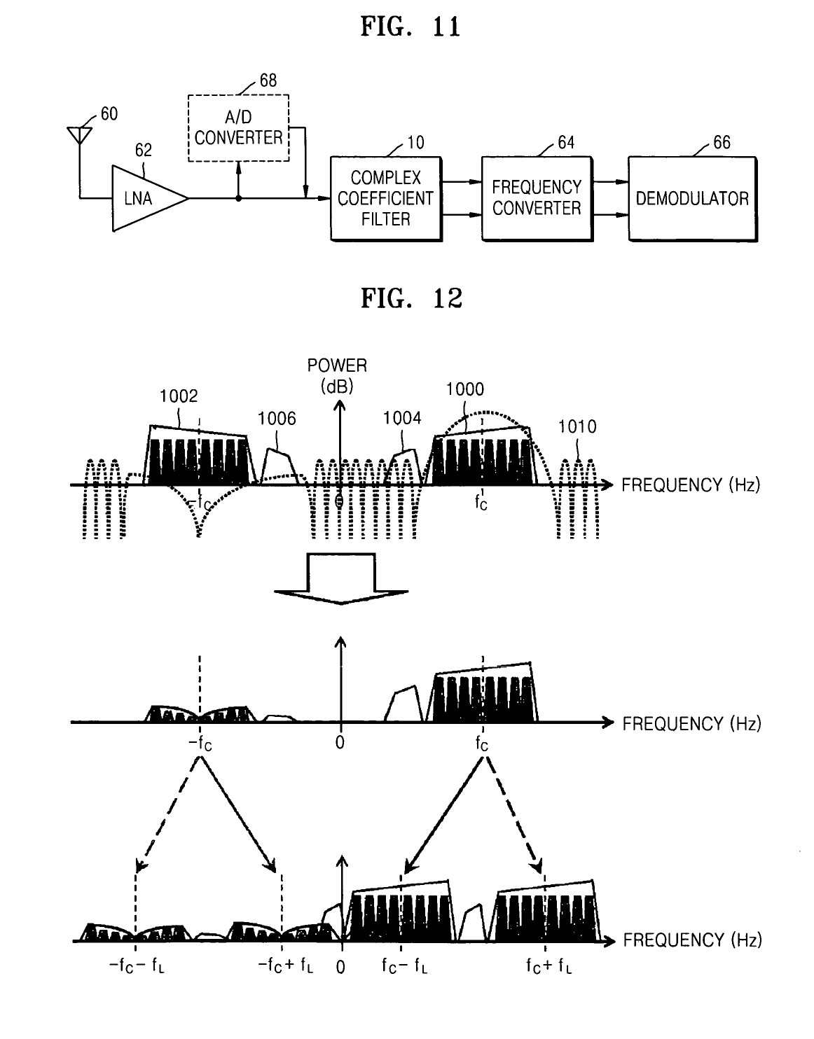

FIG. 11 is a block diagram of a receiver using a complex coefficient transversal filter 10 according to the exemplary embodiment of the present invention.

An antenna 60 receives a signal. The signal is amplified by a low noise amplifier (LNA) 62. Next, filtering is performed by a digital-circuit complex coefficient transversal filter 10 according to the first exemplary embodiment or a SAW complex coefficient transversal filter 10 according to the second exemplary embodiment. Next, the signal is subject to demodulation in a frequency converter 64 functioning as a down converter and a demodulator 66. The demodulator 66 demodulates a modulated signal into a baseband. In the case of the digital-circuit complex coefficient transversal filter 10, an A/D converter 68 denoted by a dashed line is inserted between an LNA 62 and the complex coefficient filter 10 of a transversed format.

Now, operations of suppressing an image using the complex coefficient filter according to the exemplary embodiment of the present invention will be described.

The first graph of FIG. 12 shows an RF signal before filtering in the low-IF receiver using the complex coefficient transversal filter which removes an image according to the exemplary embodiment of the present invention.

A desired signal having a central frequency of fc is denoted by a system signal 1000 of a multi-band or wide-band system. An image signal 1002 associated with the system signal 100 has a central frequency of −fc. In addition, other system signals or noise 1004 exist in the vicinity of the system signal. For example, in the first graph of FIG. 12, other system signals or noise 1004 exist in a slightly lower frequency band than the frequency of the system signal. These signals overlap, and an image signal 1006 of the other system signals or noise exists in the vicinity of the image signal (the left side of the image signal in FIG. 12). The complex coefficient transversal filter has bandpass characteristics 1010, passing the system signal having the central frequency of fc and blocking the image signal having the central frequency of −fc.

The second graph of FIG. 12 shows an RF signal after filtering in the low-IF receiver using the complex coefficient transversal filter which removes an image according to the exemplary embodiment of the present invention.

The system signal passes through the frequency converter almost without attenuation. Due to large attenuation of the image signal by the complex coefficient transversal filter 10, the image signal cannot pass. Other system signals or noise exist at the ends of the pass band and pass with slight attention, so that other system signals or noise are in the vicinity of the system signal. Similar to the image signal of the system signal 100, the image signal of other system signals or noise cannot pass. Thus, the pass stage of the complex coefficient transversal filter 10 can remove most image signals.

The third graph of FIG. 12 shows an RF signal after frequency conversion in the low-IF receiver using the complex coefficient transversal filter which removes an image according to the exemplary embodiment of the present invention.

The IF (=fc−fL) of the low-IF filter is lower than that of a super-heterodyne filter. For example, the IF is selected from a range below a few MHz. In FIG. 12C, since the difference in frequency between signals having central frequencies of fc−fL and fc+fL is large, it is easy to extract only the signal having the central frequency of fc−fL. In addition, although the desired frequency fc−fL transformed from the system signal overlaps the frequency −fc+fL of the image signal of other system signals or noise 1004, the image signal is sufficiently suppressed by the complex coefficient transversal filter, and the reception performance is maintained. In addition, substantially the same functions and operations can be applied to a direct-conversion communication system.

Now, a low-IF communication system using the complex coefficient transversal filter 10 will be described in comparison with a related art super-heterodyne communication system.

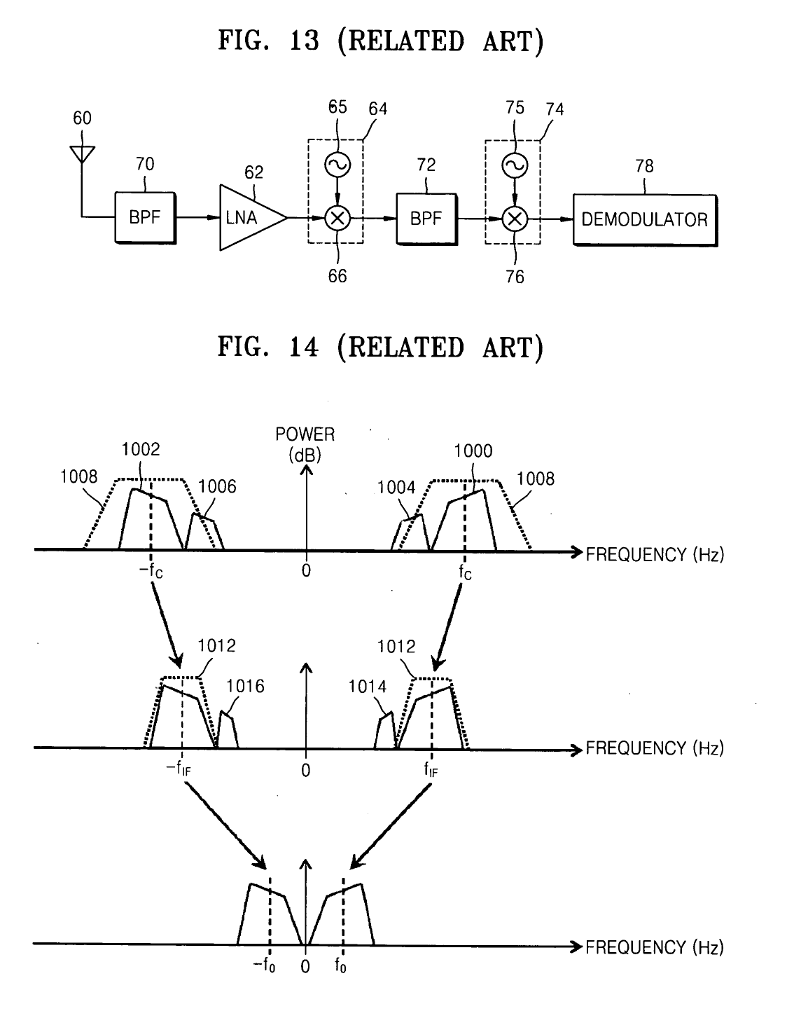

FIG. 13 is a block diagram of a super-heterodyne receiver.

An antenna 60 receives a signal. The signal is input to an RF BPF, so that a desired frequency is selected. Next, the signal is amplified by an LNA 62. In a mixer 66, the amplified signal is multiplied with a local signal from a local oscillator 65 to be transformed into an IF band signal.

FIG. 14 is a schematic view showing signals at stages of the super-heterodyne receiver shown in FIG. 13.

The first graph of FIG. 14 shows the RF signal of the super-heterodyne receiver.

Real signals in the RF stage are a system signal 1000 which exists in the vicinity of the central frequency fc, and other system signals or noise 1004 which exist in a frequency band slightly lower than the central frequency fc. In the RF BPF 1008 having pass characteristics denoted by a dotted line, other system signals or noise cannot be sufficiently removed. In the vicinity of the frequency −fc, an image including repetition of these signals occurs.

The second graph of FIG. 14 shows the IF signal of the super-heterodyne receiver.

Real signals of the IF stage are a local oscillating signal fL from the local oscillator 65 which is multiplied with a signal having a central frequency fc in a mixer 66, so that the IF signal f_{IF} is generated. At this time, other system signals or noise 1004 are also subject to frequency conversion, and after that, other system signals or noise 1004 occur in the vicinity of the IF signal f_{IF} (1014). In addition, an image including repetition of these signals occurs in the vicinity of a negative IF signal −f_{IF} (1016). Filtering is performed by an IF BPF having narrow-band, rapid attenuation characteristics (1012), to remove other frequency-converted system signals or noise shown in the second graph of FIG. 14. In general, the IF in such a super-heterodyne communication system is as high as tens or hundreds of MHz. In the embodiment, the image suppression is performed by double filtering of the RF and IF BPFs 70 and 72.

The third graph of FIG. 14 shows a signal at the last stage of the super-heterodyne receiver.

In comparison with the super-heterodyne receiver, the direct-conversion communication system shown in FIG. 11 does not need an RF BPF, and signals are input directly to the complex coefficient transversal filter 10 instead of via an RF BPF. In addition, since the frequency of the IF signal is lower than that of the super-heterodyne communication system, or the IF signal does not exist, an IF BPF having wide-band, rapid-attenuation characteristics is not needed. Accordingly, in the direct-conversion communication system using the complex coefficient transversal filter 10 according to the exemplary embodiment of the present invention, the suppression of the image signal can be performed without double filtering, so that the system can be simplified.

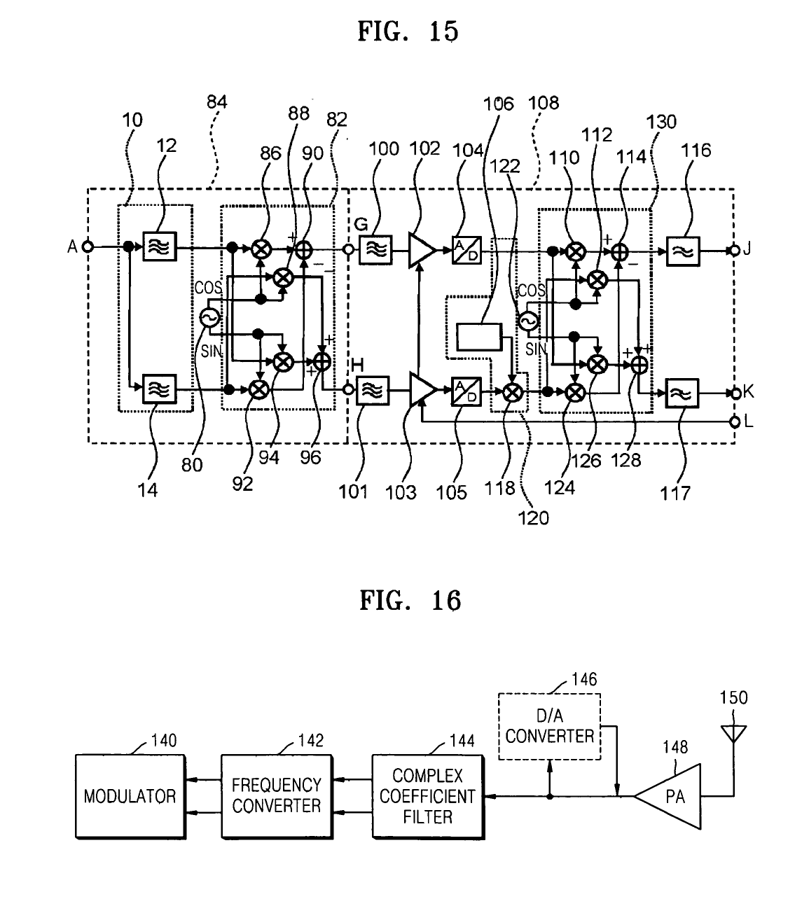

FIG. 15 is a block diagram of a low-IF receiver using the complex coefficient transversal filter which removes an image according to the exemplary embodiment of the present invention.

In the real signal generator 12 of the complex coefficient transversal filter 10 according to the first or fifth embodiment, a real signal is input to the terminal A, and the real part of a complex signal is output. In the imaginary signal generator 14, the real signal is input to the terminal A, and the imaginary part of the complex signal is output. The real and imaginary signals have a phase difference of 90°.

A local oscillator 80 outputs a complex local signal having a frequency equal to the difference in frequency between the RF and IF signals and including a cosine wave as a real part and a sine wave as an imaginary part. The direct-conversion communication system uses a local signal having a frequency equal to that of the RF signal. A mixer 86 of a complex mixer unit 82 multiplies the output of a real-side transversal filter 12 with the real part of the complex local signal and inputs the result to a positive input terminal of a subtractor 90. A mixer 94 multiplies the output of the real-side transversal filter 12 with the imaginary part of the complex local signal and inputs the result to one-side input terminal of an adder 96.

A mixer 88 multiplies the output of an imaginary signal generator 14 with the real part of the complex local signal and inputs the result to other-side input terminal of the adder 96. A mixer 92 multiplies the output of the imaginary signal generator 14 with the imaginary part of the complex local signal and inputs the result to a negative input terminal of the subtractor 90.

The subtractor 90 subtracts the output signal of the mixer 92 from the output signal of the mixer 86 and outputs the result as a real part of the complex signal to a terminal G. The adder 96 adds the output signal of the mixer 88 to the output signal of the mixer 94 and outputs the result as an imaginary part of the complex signal to a terminal H.

A baseband generator 108 includes BPFs 100 and 101, automatic gain control (AGC) amplifiers 102 and 103, A/D converters 104 and 105, a local oscillator 122, a full complex mixer 130, an unbalance compensator 120, and LPFs 116 and 117.

The BPFs 100 and 101 pass the input complex signal in frequency bands having negative and positive IF signal frequencies as central frequencies, and output a complex signal. The AGC Amplifiers 102 and 103 control gain according to an input voltage of a terminal L.

The A/D converters 104 and 105 convert analog outputs of the AGC amplifiers 102 and 103 into digital signals and input the output complex signals to the unbalance compensator 120. The A/D conversion allows the following demodulator to carry out digital signal processing.

The unbalance compensator 120 includes a compensation-value memory 106 and a multiplier 118, and digitally compensates for differences in amplitude and phase between the output signals of the two A/D converters 104 and 105. As a result, the image suppression in a desired frequency band can be effectively carried out. The compensation-value memory 106 stores compensation values of an amplitude ratio and a phase difference of an analog signal processing unit before the two A/D converters 104 and 105. The multiplier 118 multiplies the output signal of the A/D converter 105 with the compensation value input from the compensation-value memory 106 and outputs the result.

The local oscillator 122 outputs a complex local signal having the same frequency as the IF signal. Since the complex mixer unit 130 has the same construction as the complex mixer unit 82, baseband signals having zero-frequency components can be obtained as complex signals from terminals J and K. Such a down converter allows a multi-band, wide-band portable radio communication receiver to remove an image.

The exemplary embodiment of the present invention is not limited to a receiver, and may be applied to a transmitter to suppress an image. A transmitter using the complex coefficient transversal filter to remove an image will now be described.

FIG. 16 is a block diagram of a transmitter using the complex coefficient transversal filter to remove an image.

The baseband signal is modulated by a modulator 140. Next, the signal is subject to up-conversion in a frequency converter 142, and the result is input to a complex coefficient transversal filter 144. The result is amplified by a power amplifier (PA) 138, and transmitted through a transmission antenna 140. In the case of the digital-circuit complex coefficient transversal filter 144, that is, a digital filter, a D/A converter 146 is inserted between the amplifier 148 and the complex coefficient transversal filter 144.

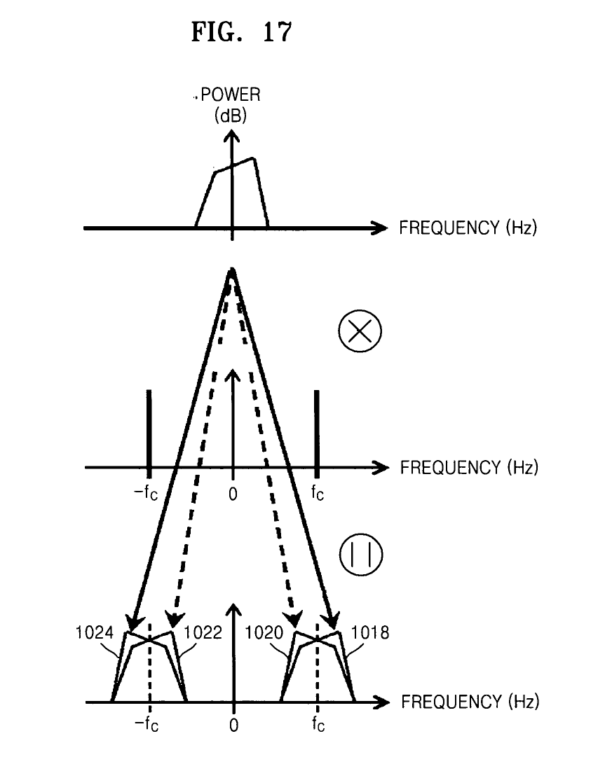

FIG. 17 is a graph showing baseband signals and RF in the direct-conversion transmitter.

Due to the frequency converter 142, a signal is multiplied with the local real signal in the mixer, and as shown in FIG. 17B, a desired frequency signal 1018 and an image interference signal 1020 are generated in the vicinity of the central frequency fc. Similarly, image signals 1022 and 1024 are generated in the vicinity of the frequency −fc.

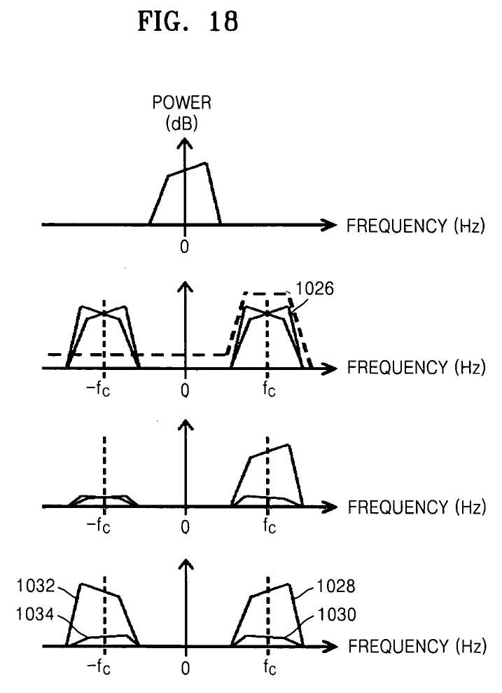

FIG. 18 is a schematic view for explaining image suppression using the complex coefficient transversal filter 134 according to the exemplary embodiment of the present invention.

The first graph of FIG. 18 shows a baseband signal in the direct-conversion transmitter using the complex coefficient transversal filter which removes an image according to the exemplary embodiment of the present invention.

The second graph of FIG. 18 shows an RF signal 1026 before filtering in the direct-conversion transmitter using the complex coefficient transversal filter which removes an image according to the exemplary embodiment of the present invention.

The third graph of FIG. 18 shows an RF signal after filtering in the direct-conversion transmitter using the complex coefficient transversal filter which removes an image according to the exemplary embodiment of the present invention.

The fourth graph of FIG. 18 shows a transmitted RF signal in the direct-conversion transmitter using the complex coefficient transversal filter which removes an image according to the exemplary embodiment of the present invention.

A complex signal at the baseband stage is subject to up-conversion. At the RF stage before filtering, a desired frequency signal 1028 and an image interference signal 1030 are generated in the vicinity of the central frequency fc, and image signals 1032 and 1034 are generated in the vicinity of the frequency −fc.

The complex coefficient transversal filter 134 has pass characteristics denoted by a dotted line, and the image signals in the vicinity of the frequency −fc are greatly attenuated. Therefore, it is possible to obtain a transmission output of a real signal with little image influence. The up-converter and the transmitter using the up-converter are suitable for a multi-band, wide-band portable radio communication system.

According to the exemplary embodiments of the present invention, it is possible to improve the image suppression ratio over a wide band with a complex coefficient transversal filter by using a phase delay of real and imaginary signals. In addition, it is possible to reduce the circuit size and power consumption.

While the present invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only and not for purposes of limitation.

For example, circuit elements, SAW materials, or the shape, size, and arrangement of the electrodes in a complex coefficient transversal filter may be modified in various ways by those of ordinary skill in the art, and these modifications are included in the invention and the spirit of the invention. Therefore, the scope of the invention is defined not by the detailed description of the invention but by the appended claims, and all differences within the scope should be construed as being included in the present invention.

What is claimed is:

1. A complex coefficient transversal filter comprising:
a real signal generator which generates at least two real delay signals by delaying an input signal by an integer multiple of one period, generates at least two real multiplied signals by multiplying the input signal and at least one of the real delay signals by an absolute value of a real variable tap coefficient, and generates a real signal by sequentially adding at least two of the generated real multiplied signals; and
an imaginary signal generator which generates a phase delay signal by delaying the input signal by half a period, generates at least two imaginary delay signals by delaying the phase delay signal by an integer multiple of one period, generates at least two imaginary multiplied signals by multiplying the phase delay signal and at least one of the imaginary delay signals by an absolute value of an imaginary variable tap coefficient, and generates an imaginary signal by sequentially adding a plurality of the generated imaginary multiplied signals.

2. The complex coefficient transversal filter of claim 1, wherein the real signal generator comprises M real signal coefficient multipliers, each of which generates a real multiplied signal of the real multiplied signals by multiplying the phase delay signal and at least one of the real delay signals by the absolute value of the real variable tap coefficient, and M is an integer of 5 or more.

3. The complex coefficient transversal filter of claim 2, wherein the imaginary signal generator comprises (M−1) imaginary signal coefficient multipliers, each of which generates an imaginary multiplied signal of the imaginary multiplied signals by multiplying the phase delay signal and at least one of the imaginary delay signals by the absolute value of the imaginary variable tap coefficient.

4. The complex coefficient transversal filter of claim 1,
wherein the real signal generator comprises (M−1) adders, each of which receives at least two of the real multiplied signals through a polarity allocating terminal and adds the real multiplied signals input through the polarity allocating terminal to generate the real signal, and M is an integer of 5 or more, and
wherein the polarity allocating terminal alternately allocates positive and negative polarities to the input signal.

5. The complex coefficient transversal filter of claim 1,
wherein the imaginary signal generator comprises (M−2) adders, each of which receives at least two of the imaginary multiplied signals through a polarity allocating terminal and adds the imaginary multiplied signals input through the polarity allocating terminal to generate the imaginary signal, and
wherein the polarity allocating terminal alternately allocates positive and negative polarities to the input signal.

6. The complex coefficient transversal filter of claim 3, wherein the M real signal coefficient multipliers comprise:
first, second, and M-th real signal coefficient multipliers having an absolute value of the real variable tap coefficient less than 1; and
third to (M−2)-th real signal coefficient multipliers having an absolute value of the real variable tap coefficient equal to 1.

7. The complex coefficient transversal filter of claim 6, wherein the (M−1) imaginary signal coefficient multipliers comprise:
first and (M−1)-th imaginary signal coefficient multipliers having an absolute value of the imaginary variable tap coefficient in the range of a sum of the absolute values of the real variable tap coefficients of the first and second real signal coefficient multipliers multiplied by 0.4 to 0.6; and
second to (M−2)-th imaginary signal coefficient multipliers having an absolute value of the imaginary variable tap coefficient equal to 1.

8. The complex coefficient transversal filter of claim 1,
wherein the real signal generator comprises (M−1) real signal delayers, each of which delays a received signal by one period to output one of the real delay signals, and
wherein the (M−1) real signal delayers are arrayed in series.

9. The complex coefficient transversal filter of claim 1, wherein the imaginary signal generator comprises:
a phase delayer which delays the input signal by half a period to generate the phase delay signal; and
(M−2) imaginary signal delayers, each of which delays a received signal by one period to output the imaginary delay signal, and
wherein a first imaginary signal delayer of the (M−2) imaginary signal delayers is connected in series with the phase delayer, and the (M−2) imaginary signal delayers are connected in series with each other.

10. The complex coefficient transversal filter of claim 1, further comprising a transmission electrode unit which transforms the input signal into a surface acoustic wave (SAW) signal and outputs the SAW signal to the real and imaginary signal generators.

11. The complex coefficient transversal filter of claim 10, wherein the transmission electrode unit comprises positive and negative transmission electrodes comprising comb-like fingers facing each other on a substrate made of a piezoelectric material, and
wherein the transmission electrode unit receives an electrical signal through an input terminal of the transmission electrode unit which is connected to the positive and negative transmission electrodes and transmits the SAW signal through output terminals of the transmission electrode unit which are respectively connected to the positive and negative transmission electrodes.

12. The complex coefficient transversal filter of claim 10, wherein the real signal generator comprises positive and negative real electrodes comprising comb-like fingers facing each other on a substrate made of a piezoelectric material, and
wherein the real signal generator receives the SAW signal through a real input terminal which is connected to the positive and negative real electrodes and applies an electrical signal through a real output terminal.

13. The complex coefficient transversal filter of claim 10, wherein the imaginary signal generator comprises positive and negative imaginary electrodes comprising comb-like fingers facing each other on a substrate made of a piezoelectric material, and
wherein the imaginary signal generator receives the SAW signal through an imaginary input terminal which is connected to the positive and negative imaginary electrodes and applies an electrical signal through an imaginary output terminal.

14. The complex coefficient transversal filter of claim 12, wherein the real electrode unit adjusts the absolute value of the real variable tap coefficient according to a degree of overlap of the fingers of the positive and negative real electrodes.

15. The complex coefficient transversal filter of claim 13, wherein the imaginary electrode unit adjusts the absolute value of the imaginary variable tap coefficient according to a degree of overlap of the fingers of the positive and negative imaginary electrodes.

16. The complex coefficient transversal filter of claim 12, wherein the real electrode unit comprises an alternating arrangement of the fingers of the positive and negative real electrodes.

17. The complex coefficient transversal filter of claim 13, wherein the imaginary electrode comprises an alternating arrangement of the fingers of the positive and negative imaginary electrodes.

18. The complex coefficient transversal filter of claim 12, wherein the real electrode unit adjusts a delay time according to a pitch of the real fingers.

19. The complex coefficient transversal filter of claim 13, wherein the imaginary electrode unit adjusts a delay time according to a pitch of the imaginary fingers.

20. A filtering method, comprising:
generating a real signal by delaying an input signal by a first value to generate a real delay signal, multiplying the real delay signal by a second value to generate a plurality of real multiplied values, and sequentially adding the real multiplied values; and
generating an imaginary signal by delaying the input signal by a third value to generate an imaginary delay signal, multiplying the imaginary delay signal by a fourth value to generate a plurality of imaginary multiplied values, and sequentially adding the imaginary multiplied values.

21. The filtering method of claim 20, wherein generating the real signal comprises:
delaying the input signal by an integer multiple of one period to generate a plurality of real delay signals;
multiplying the input signal and at least one of the real relay signals by the absolute value of a real variable tap coefficient to generate the real multiplied signals; and
sequentially adding the real multiplied signals to generate the real signal.

22. The filtering method of claim 20, wherein generating the imaginary signal comprises:
delaying the input signal by half a period to generate a phase delay signal;
delaying the phase delay signal by an integer multiple of one period to generate a plurality of imaginary delay signals;
multiplying the phase delay signal and at least one of the imaginary delay signals by the absolute value of an imaginary variable tap coefficient to generate the imaginary multiplied signals; and
sequentially adding the imaginary multiplied signals to generate the imaginary signal.

23. A receiver comprising:
a complex coefficient transversal filter which generates a real signal by delaying an input signal by a first value to generate a real delay signal, multiplying the real delay signal by a second value to generate a plurality of real multiplied values, and sequentially adding the real multiplied values, and generates an imaginary signal by delaying the input signal by a third value to generate an imaginary delay signal, multiplying the imaginary delay signal by a fourth value to generate a plurality of imaginary multiplied values, and sequentially adding the imaginary multiplied values;
a frequency converter which converts a frequency of a signal generated by a complex coefficient transversal filter; and
a demodulator which demodulates a signal converted by the frequency converter.

24. A transmitter comprising:
a modulator which modulates a baseband signal;
a frequency converter which converts a frequency of a signal modulated by the modulator; and
a complex coefficient transversal filter which generates a real signal by delaying the signal converted by the frequency converter by a first value to generate a real delay signal, multiplying the real delay signal by a second value to generate a plurality of real multiplied values, and sequentially adding the real multiplied values, and generates an imaginary signal by delaying the signal converted by the frequency converter by a third value to generate an imaginary delay signal, multiplying the imaginary delay signal by a fourth value to generate a plurality of imaginary multiplied values, and sequentially adding the imaginary multiplied values.
